(19) United States
(12) Patent Application Publication
(10) Pub. No.: US 2026/0342181 A1
(43) Pub. Date: Oct. 29, 2026

(54) Additively Manufactured Magnetic Lamination, Laminated Core And Method For Manufacturing A Magnetic Lamination

(71) Applicant: Siemens Aktiengesellschaft, München (DE)

(72) Inventors: Rolf Vollmer, Gersfeld (DE); Carsten Schuh, Baldham (DE)

(73) Assignee: Siemens Aktiengesellschaft, München (DE)

(21) Appl. No.: 19/106,009

(22) PCT Filed: Jul. 14, 2023
(86) PCT No.: PCT/EP2023/069618

§ 371 Date: Feb. 24, 2025

(30) Foreign Application Priority Data
Aug. 31, 2022 (EP) 22193218.9

(51) Int. Cl. H02K 15/0273; H02K 1/22

(52) U.S. Cl. CPC H02K 15/0273; H02K 1/22

(57) ABSTRACT

Various embodiments of the teachings herein include an additively manufactured rotationally symmetric magnetic lamination. An example includes: at least two material layers for a laminated core of an electrical machine and a first material component and a second material component forming a material layer layout. Each material layer comprises at least two material components separate from one another in their planar extent. The at least two material layers have the same material layer layout as the two material components. A layout of the at least two material layers is rotationally shifted by a non-zero angle.

### CROSS-REFERENCE TO RELATED APPLICATIONS

This application is a U.S. National Stage Application of International Application No. PCT/EP2023/069618 filed Jul. 14, 2023, which designates the United States of America, and claims priority to EP Application No. 22193218.9 filed Aug. 31, 2022, the contents of which are hereby incorporated by reference in their entirety.

### TECHNICAL FIELD

The present disclosure relates to additive manufacturing. Various embodiments of the teachings herein include magnetic laminations, laminated cores, and processes for producing a magnetic lamination.

### BACKGROUND

Screen printing or stencil printing for producing magnetic laminations for electric machines comprises printing a printing paste onto a substrate using a stencil, the open regions of which may also be provided with a screen. Reference is made in this respect to stencil printing or screen printing, stencil printing being an umbrella term covering screen printing. In addition to solvents and/or binders, the printing paste contains metal powders, which have a functional action in the resulting component. The screen printing technique results in production of a green body, which after a further heat treatment firstly generally has the binder removed and then is fed to a sintering process at a higher temperature, the metallic powder grains being sintered to one another such that a structured lamination, the magnetic lamination, is produced.

To achieve a higher mechanical strength of such laminations, in particular in the case of high rotor speeds in electric machines, the producibility of two-component magnetic laminations is becoming increasingly important. An example for this is described in EP 3723249 A1. Further examples include EP 3 629 453 A1, EP 3 932 591 A1 and EP 3 725 435 A1. A fundamental problem with such two-component magnetic laminations produced by stencil printing is that the different materials, if they for the one part have good magnetic properties and for the other part have a high strength, generally have different coefficients of thermal expansion. Thus, for example, a high-strength steel constituting a subcomponent for the mechanical strength of the magnetic lamination has coefficient of expansion of 16×10−6 K−1. A further soft-magnetic material has a coefficient of thermal expansion of between 10-12×10−6 K−1 in a temperature range between 0 °C and 100 °C. During the joint sintering of such different material components, or material pairs, in a green body to afford a magnetic lamination, high mechanical stresses form in the connecting, or seam, regions between these material components owing to these different coefficients of thermal expansion, in particular when the sintering temperatures are being cooled down to room temperature. This can lead to deformations or to cracks or altogether to mechanical stresses in the magnetic lamination which can significantly impair the mechanical or magnetic properties.

### SUMMARY

Teachings of the present disclosure provide magnetic laminations, laminated core, and electric machines in which the magnetic lamination has a higher strength and fewer intrinsic stresses compared to the prior art when using at least two material components within the magnetic lamination. For example, some embodiments of the teachings herein include an additively manufactured £ rotationally symmetric magnetic lamination (2) comprising at least two material layers 4, 6 for a laminated core (8) of an electrical machine (10), wherein each material layer 4, 6 comprises at least two material components (12, 14) separate from one another in their planar extent a first material component (12) and a second material component (14), wherein the material components 12, 14 form a material layer layout 16, characterized in that the at least two material layers 4, 6 have the same material layer layout 16 of the two material components 12, 14 and the layout 16 of the at least two material layers 4, 6 is rotationally shifted by an angle α.

In some embodiments, at least three material layers 4, 6, 6′ are provided, wherein a third material layer 6′ is likewise rotationally shifted by the angle α in the same direction relative to a second material layer 6.

In some embodiments, the at least two material layers 4, 6 are bonded to one another via a sinter bond.

In some embodiments, a thickness 18 of the magnetic lamination 2 is between 300 μm and 2000 μm.

In some embodiments, the material layers 4, 6 have a thickness between 10 μm and 150 μm.

In some embodiments, the first material component (12) comprises an iron alloy which has an austenitic microstructure to an extent of at least 25% by volume.

In some embodiments, the second material component (14) comprises an iron alloy comprising at least 95% by weight, especially at least 97% by weight, of iron.

In some embodiments, the second material component (14) has a ferritic or martensitic microstructure.

In some embodiments, the first material component (12) is an iron-chromium-nickel alloy.

In some embodiments, the first material component (12) is an iron-chromium alloy having a chromium content between 22% by weight and 28% by weight, especially between 24% by weight and 26% by weight.

In some embodiments, the first material component (12) has a nickel content between 4% by weight and 10% by weight, especially between 6% by weight and 8% by weight.

As another example, some embodiments include a laminated core for a rotor (38) of an electric machine (10) comprising a plurality of magnetic laminations (2) as described herein.

In some embodiments, an uppermost material layer of a first magnetic lamination and a lowermost material layer of a second magnetic lamination are shifted by the angle α.

In some embodiments, the sum of the angles α in the laminated core 8 is between 7° and 36°.

As another example, some embodiments include a process for producing a magnetic lamination comprising, a) applying a first printing paste 22 onto a substrate 28 by stencil printing 30 through a stencil 26, b) applying a second printing paste 24 to the substrate 28 such that the two printing pastes 22, 24 are arranged side by side, form a discrete boundary 32 and form a first material layer 4, c) drying the first material layer 4, d) rotating the orientation of the substrate 28 and/or the stencil 26 about a perpendicular axis 34 to the substrate 28 by an angle α, e) applying a second material layer 6 after steps a) to c), f) sintering a green body 36 produced by a) to e) to afford a magnetic lamination.

### BRIEF DESCRIPTION OF THE DRAWINGS

Example embodiments of the teachings herein and further features are more particularly described with reference to the following figures. Features having the same designation but appearing in different embodiments have the same reference numeral. The figures are purely schematic representations that do not in themselves constitute a restriction of the scope of protection. In the figures:

FIG. 1 shows an exploded view of a typical electric machine having a housing, rotor and stator, which may be an electric motor or a generator;

FIG. 2 shows a laminated core comprising stacked magnetic laminations according to the prior art;

FIG. 3 shows a plan view of a two-component magnetic lamination incorporating teachings of the present disclosure;

FIG. 4 shows a perspective plan view of a two-component magnetic lamination with a different layout than in FIG. 3, incorporating teachings of the present disclosure;

FIG. 5 shows an enlarged representation of section V in FIG. 4;

FIG. 6 shows an enlarged representation of section VI in FIG. 5 in which an overlap region of the individual material layers is visible; and

FIG. 7 shows a schematic representation of a production process for producing the described magnetic lamination incorporating teachings of the present disclosure.

### DETAILED DESCRIPTION

As an example of the teachings herein, an additively manufactured rotationally symmetric magnetic lamination may include at least two material layers and the magnetic lamination serves as a constituent of a laminated core of an electric machine, wherein each material layer of the magnetic lamination comprises at least two material components separate from one another in their planar extent. A first material component and a second material component together form a material layer layout. At least two material layers have the same material layer layout of the two material components. The layouts of at least two material layers are rotationally shifted relative to one another by an angle α. Rotationally is to be understood as meaning about a perpendicular axis to the lamination plane which passes through the center point of the rotationally symmetric magnetic lamination.

In the prior art, printed two-component magnetic laminations are in each case constructed from a singular material layer. In contrast, in the example described, this present magnetic lamination is composed of a plurality of material layers. These are arranged one above the other in a stack. At least two material layers each have the same layout of the two material components and are each rotationally shifted relative to one another by an angle α. It is generally the case that more than two material layers having the same layout are arranged one above the other. This may be effected by a stencil printing or screen printing process, wherein in the described magnetic lamination these layers each have a rotational shift by the angle α relative to the layer following below. In the case of a plurality of material layers the shift by the angle α is summed to form an overlap region which de facto has an average coefficient of thermal expansion which has a gradient in its planar extent and in each case has a value between the individual coefficients of thermal expansion of the first and the second material component. This has the result that thermomechanical stresses between the regions of the individual material components (especially during cooling from sintering temperature) are markedly reduced, thus ensuring a higher mechanical strength at high rotational speeds of the magnetic lamination/the laminated core constructed therefrom.

The described construction can eliminate torque variations in the electric machine in which the magnetic lamination/the laminated core resulting therefrom is employed over a relatively wide range. The described material layers that are correspondingly rotated relative to one another are integral constituents of the respective screen-printed or stencil-printed magnetic lamination. The material layers are accordingly not individual distinct magnetic laminations but rather the individual material layers are preferably bonded to one another by a sinter bond brought about by a sintering process of the entire magnetic lamination, thus forming a magnetic lamination.

The following definitions shall be used in the remainder of the document: The magnetic lamination and the individual magnetic layers proceed from a green body as more particularly elucidated with regard to claim 15. The term green body is to be understood as meaning a shaped body for subsequent thermal treatment which generally contains binders and/or solvents for better shaping. A green body is per se generally mechanically self-supporting and is mechanically stressable to a limited extent. A green body freed of these binders and/or solvents is in the present context referred to as a precursor. The precursor contains only the functional constituents, generally metal particles, of the final body, which also play an active role in the sintering process. The heat treatment in the form of a sintering operation, where, unlike in a melting operation, individual grains (particles) in the precursor form a cohesive, materially bonded structure via diffusion processes, converts the precursor into a sintered body. Once the sintering operation has been performed the resulting body is in this context referred to as a magnetic lamination. This magnetic lamination may be subjected to various post-processing operations.

The described material layers are supplied to the sintering process together and form a sinter bond also in their planar interfaces.

A stencil printing process indicates a process in which a printing paste is applied to a substrate by means of a doctor blade for example, to form a layer which, as described, comprises solvents, binders and functional particles. The paste is printed onto a substrate only on certain uncovered regions that are kept free using a stencil. The paste is typically printed through a screen but this is not compulsory. Stencil printing using a screen is referred to as a screen printing process, which is why the screen printing process is conceptually subsumed under the stencil printing process. However, the term screen printing process also encompasses the umbrella term stencil printing process.

In the sintered state magnetic laminations typically have a thickness between 70 μm and 300 μm, especially between 100 μm and 250 μm. By contrast, the present magnetic lamination has a thickness which may be between 300 μm and 2000 μm. This results from the described individual material layers which in turn are individually thinner than a customary magnetic lamination according to the prior art and preferably have a thickness between 10 μm and 100 μm. This has the result that a number between 10 and 20 material layers is advantageous for a magnetic lamination. It may be further advantageous that the greater layer thickness in the green body and in the subsequent sintering operation results in higher strengths and stiffnesses with regard to deformations and delaminations. In operation of the magnetic lamination this results in higher mechanical strengths, especially tensile strengths and flexural strengths/fatigue strengths which enables higher rotational speeds in the case of a rotor whose substantial constituent is a laminated core made of the described magnetic laminations.

As described, the magnetic lamination comprises at least two different material components which differ especially in their mechanical and magnetic properties. This makes it possible to specifically focus on the technical properties required in certain regions of the magnetic lamination. The first material component therefore comprises an iron alloy which comprises an austenitic microstructure to an extent of at least 25% by volume. This austenitic microstructure which is achievable especially through highly alloyed steels has a very high strength, especially tensile and flexural strength.

By contrast, the second material component comprises an iron alloy comprising at least 95% by weight, especially at least 97% by weight, of iron. In some embodiments, the second material component is pure iron, which has especially good magnetic properties, especially soft-magnetic properties, and which is very readily remagnetizable through hysteresis. It should be noted that information regarding the austenitic microstructure is specified in % by volume and information regarding alloying is specified in % by weight. This is because microstructures are more readily specifiable microscopically in microsections in % by volume and the alloying constituents shall hereinbelow be specified in % by weight which is customary in the art and represents unambiguous manufacturing instructions in the composition of an alloy.

The second material component which has very good soft-magnetic properties in turn has a preferred ferritic and/or martensitic microstructure.

The first material component, which has the high mechanical strength and ensures the strength of the overall magnetic lamination during rotational motion, may comprise an iron-chromium-nickel alloy. This may have a chromium content of between 22% by weight and 28% by weight, especially between 24% by weight and 26% by weight. The nickel content of the described iron-chromium-nickel alloy furthermore has a proportion of between 4% by weight and 10% by weight, especially between 6% by weight and 8% by weight.

Another example embodiment includes a laminated core for a rotor of an electric machine which comprises a plurality of magnetic laminations as described herein. The advantages of this laminated core, especially as a constituent of a rotor of an electric machine, have already been extensively described while describing the advantages of the individual magnetic lamination. Such a laminated core especially has a higher tolerance towards higher temperatures occurring at high rotational speeds, thus resisting delamination of a two-component magnetic lamination produced by screen printing or stencil printing processes.

Since the described laminated core comprises a plurality of magnetic laminations having the described properties it is advantageous to continue the construction of the individual magnetic lamination in the case of stacking of a plurality of magnetic laminations such that preferably an uppermost material layer of a first magnetic lamination and a lowermost material layer of a second magnetic lamination are each also shifted relative to one another by an angle α. The total angle of the angles α in the overall laminated core is preferably between 7° and 36°. This total displacement is firstly suitable for providing a sufficiently large overlap region of any magnetic lamination in order therein to reduce the coefficient of thermal expansion and secondly this total angle also ensures elimination of torque variations in the rotor over the widest possible range.

Another example includes a process for producing a magnetic lamination which comprises:
a) applying a first printing paste onto a substrate by stencil printing through a stencil,
b) applying a second printing paste to the substrate such that the two printing pastes are arranged side by side, form a discrete boundary and form a first material layer,
c) drying the first material layer,
d) rotating the orientation of the substrate and/or the stencil about a perpendicular axis to the substrate by an angle α,
e) applying a second material layer after steps a) to c),
f) sintering a green body produced by steps a) to e) to afford a magnetic lamination.

The described process for producing a magnetic lamination results in a magnetic lamination which has the same advantages as previously elucidated in the discussion of the laminations incorporating teachings of the present disclosure. The rotating of the individual material layers which finally form the magnetic lamination with respect to one another has the result that in an overlap region between the individual material components there is a respective displacement by the described angle α and thus the coefficient of thermal expansion approximates a gradient between the coefficient of expansion of the individual material components. This has a positive effect on the strength of the magnetic lamination.

To achieve the angle α the substrate may be slightly rotated or alternatively or in addition the template or the frame of the template may be slightly rotated by the angle α. Rotation of both of the described components is naturally also possible in principle. The wording according to which the two printing pastes are arranged side by side and form a discrete boundary is to be understood as meaning that overlap of the two printing pastes and optionally a confluence of the two printing pastes along the discrete boundary according to a process engineering tolerance are eminently possible and also occur. However, the discrete boundary should be as narrow as possible in practice. While a transition region between the two material components is likewise advantageous having regard to the different coefficients of thermal expansion, said region leads to different thicknesses in the region of the boundary which, by contrast, is less advantageous for the construction of the overall magnetic lamination.

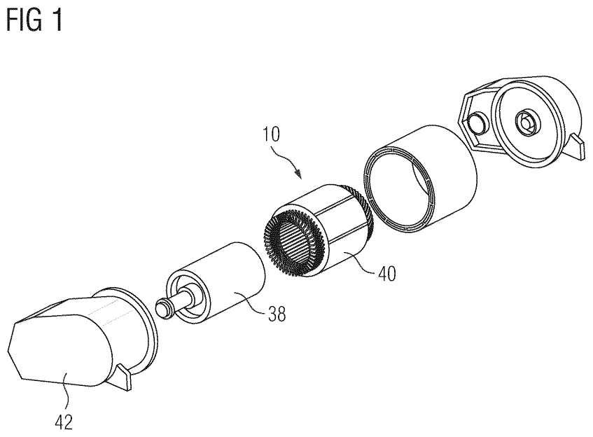

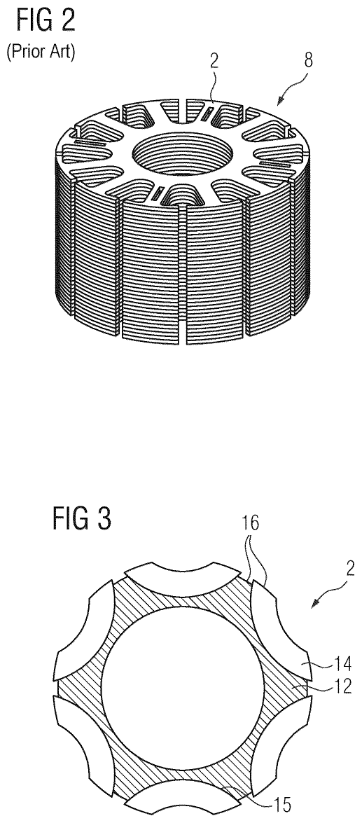

For better classification of the described magnetic lamination 2, FIG. 1 initially shows an exploded view of an electric machine 10. This comprises a rotor 38 and a stator 40 which are surrounded by a housing 42. The electric machine 10 may be an electric motor or a generator. The rotor 38 in turn comprises a laminated core 8 not explicitly shown in FIG. 1, around which electrically conductive wires are wound in a particular fashion as coils. Such a laminated core 8 according to the prior art is shown for example in FIG. 2. The laminated core 8 according to FIG. 2 comprises a stack of a multiplicity of magnetic laminations 2 according to the prior art, wherein the layout of the surface 2 is configured such that there are corresponding cutouts and grooves for the conductor windings.

FIG. 3 gives an example of a magnetic lamination 2 incorporating teachings of the present disclosure which comprises two components, a first material component 12 and a second material component 14. The two material components 12 and 14 have different technical properties. The first material component 12 may comprise a highly alloyed chromium-nickel steel which, in some embodiments, comprises more than 25% by volume of austenitic microstructure. By way of example the chromium content is 25% by weight and the nickel content is 7% by weight. Such an alloy is a stainless steel alloy having a very high strength. As is apparent in FIG. 3, the first material component 12 is arranged centrally inside the magnetic lamination 2 and during rotational motion of the rotor 38 thus bears the highest tensile stresses acting on the magnetic lamination 2 or on the laminated core 8 formed therefrom.

By contrast, the material properties of the second material component 14 may be geared towards its magnetic properties. In some embodiments, the material of the second material component 14 is pure iron and has a ferritic or martensitic microstructure. Pure iron has notable soft-magnetic properties and is easy to repolarize in this regard. This may be important for AC motors or generators.

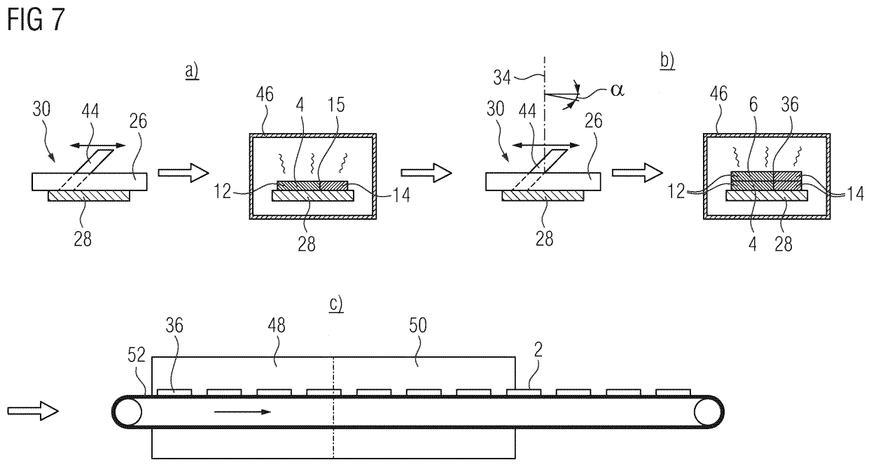

The production of a magnetic lamination 2 from at least two components such as are shown in FIG. 3 will be further elucidated below with reference to the schematic representation of FIG. 7.

Although they are generally constructed from iron alloys, the two different material components nevertheless exhibit a certain difference in their coefficient of electrical expansion. Depending on the alloy composition, the coefficient of expansion between the individual iron alloys may be between 10×10⁻⁶ K⁻¹ and 20×10⁻⁶ K⁻¹ for example. In addition, a temperature increase from room temperature to 200 °C, which in some cases may be the operating temperature of an electric high-performance machine at high rotational speeds, can likewise lead to a change in the coefficient of expansion by 10×10⁻⁶ K⁻¹. This difference between the individual coefficients of expansion depending on the material composition but also depending on the operating temperature range of the machine leads to significant thermomechanical stresses at the interface 15 between the individual material components 12 and 14. Further high thermomechanical stresses already occur upon cooling from the required sintering temperatures.

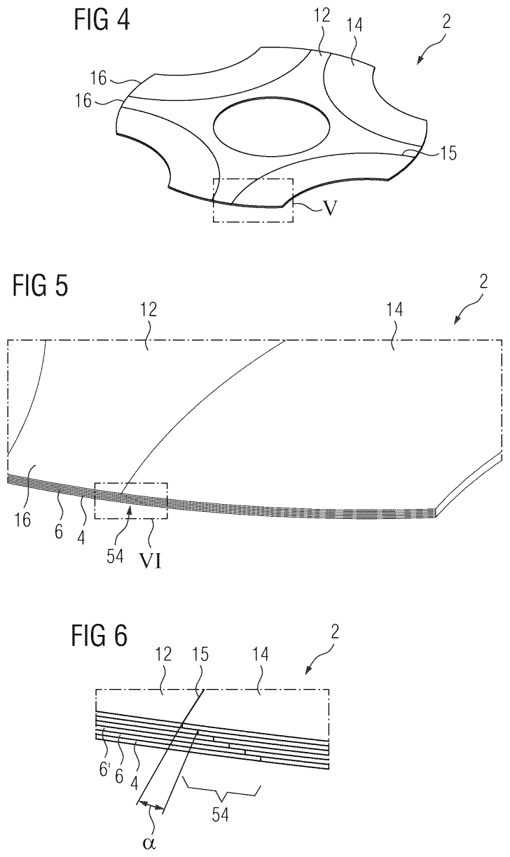

These thermomechanical stresses are brought about by the different coefficients of expansion and by the thermal variations of the machine, but may be reduced discussed herein with reference to FIGS. 4 to 6. Analogously to FIG. 3, FIG. 4 shows a magnetic lamination 2 which fundamentally corresponds to the construction of FIG. 3 but has a different layout 16. It comprises both regions comprising the first material component 12 and regions comprising the second material component 14. Interfaces 15 between the material components 12 and 14 are present here too. In the circular cutout labeled V, the two material components 12 to 14 come into contact as per their interface 15, as shown with slight magnification in FIG. 5. It is in turn apparent in the circle labeled VI that the magnetic lamination 2 is constructed from a plurality of material layers 4 and 6, namely a first material layer 4 and a second material layer 6 as well as further material layers 6′. A further enlargement of the circle VI is shown in FIG. 6.

The sequence of material layers 4 and 6 is once more shown in enlarged and clarified form. It is apparent that between the first material layer 4 and the second material layer 6 there is a rotation of the layout 16 of the two material layers, which is otherwise largely identical, by an angle α. This rotation by the angle α continues for the further material layers 6′ and the subsequent material layers 6′ which are not described but are identical within the scope of process accuracy. As is apparent in FIG. 6, this results in an overlap region 54. Taking a cross section through the overlap region 54 results in the same material proportion at the first material component 12 and the second material component 14. However, this is in the form of a gradual progression of the respective material components 12, 14. This overlap region 54 thus has a coefficient of thermal expansion which changes in the form of a gradient from the first material layer 12 to the second material layer 14. This in turn has the effect of reducing thermomechanical stresses resulting from the different base coefficients of the individual material components 12 and 14. This thus results in a gradual transition of the coefficients of expansion from one material component to the other material Component. Local thermomechanical stresses are thus greatly reduced or distributed over a larger area, thus in turn significantly increasing the strength of the magnetic lamination per se.

The magnetic lamination 2 shown in FIG. 6 comprises six material layers 4, 6, 6′. The magnetic lamination 2 according to FIG. 6 has a thickness of 600 μm and each of the individual material layers 4, 6, 6′ has a thickness of about 100 μm depending on manufacturing tolerances. A magnetic lamination 2 constructed in a manner shown in FIGS. 4 to 6 may have a thickness between 300 μm and 2000 μm. Magnetic laminations produced by conventional processes of screen printing or of stencil printing typically have a thickness of 100 μm. Compared to these laminations the magnetic lamination 2 in the form shown here has the advantage that while it also comprises individual material components, these are bonded to one another by sintering processes and through their stacking sequence ensure that the overall magnetic lamination 2 has a higher relative intrinsic strength and undergoes less distortion through deformations in the course of the sintering process.

Accordingly configured magnetic laminations 2 are stacked one on top of the other in a laminated core 8 in such a way that the displacement by the angle α, as shown in FIG. 6, is continued during stacking of the magnetic laminations 2 one above the other with the result that the angular displacement is a sum of the individual angles α. This in turn has an effect on the magnetic behavior of the laminated core 8 and the rotor 38. It has been found that a displacement of the summed angles α between 7.2° and 36° is advantageous depending on the number of pole pairs of the motor. At a high number of pole pairs of 50, a smaller displacement of the summed angle α of 7.2° may compensate for torque fluctuations in the rotor. At a low number of pole pairs of 10, an angle of 36° and at a number of pole pairs of 36 an angle sum, also known as a skew, of 10° may be useful.

FIG. 7 describes a possible process sequence by which a magnetic lamination 2 as described above may be obtained. This process sequence is described in very schematic terms in FIG. 7 and the individual process steps may be subject to technically customary variations. Initially a printing paste not shown here is printed onto a substrate 28 by means of a stencil printing process 30 and using a stencil 26 and a doctor blade 44. The stencil is then replaced or exchanged (not shown separately in FIG. 7a) and a second printing paste is printed onto the same substrate 28 so that the two material components 12 and 14 are arranged side by side on the substrate 28. In the further course of the description of the process, the individual material components are already referred to by the terms first material component 12 and second material component 14, whereas strictly speaking these are still precursors of the later material components 12 and 14 present in the magnetic lamination. In the illustration according to FIG. 7a, the material components 12 and 14 are thus the dried pastes which are freed of solvents using a drying apparatus.

According to FIG. 7b, a second step is carried out using the same stencil printing process 30, wherein a second material layer 6 is printed with the same layout 16 onto the same substrate 28, namely onto the already present and dried material components 12 and 14 which form the first material layer 4. A further drying process is carried out.

The second material layer 6 differs from the first material layer 4 in a form not visible here in that the template 26 and/or the substrate 28 were rotated by the angle α about the perpendicular axis 34 to the substrate 28.

In some embodiments, a plurality of further material layers (not shown here), which are likewise rotated in their layout with respect to the respective lower material layer by a further angle α, follow for construction of the magnetic lamination 2 or its green body 36.

Auxiliaries may be introduced between the individual material
layers. Suitable auxiliaries include for example boron, lithium and phosphorus, which contribute to a temporary liquid phase sintering in the boundary region and are subsequently incorporated into the microstructure by resorption. This results in improved bonding of the material layers to one another after the sintering process and prevents any delamination of the material layers. These auxiliaries may be applied by a spray process for example after drying of the respective material layers.

This green body 36 thus produced is then supplied to a sintering process. This may employ a sintering furnace which is often in the form of a batch furnace in which a multiplicity of components to be sintered are introduced and heated to a sintering temperature and then cooled again.

However, FIG. 7c shows an example embodiment, wherein the green bodies 36 are passed into a continuous furnace via a conveyor belt 52, wherein said furnace is divided into two subregions, into a debindering furnace 48 wherein organic constituents from the green body 36 are initially thermally decomposed and removed, and into a sintering furnace 50 in which the green body is heated to a sintering temperature at which diffusion processes between the individual particles of the material components applied by stencil printing take place. The components are referred to as the magnetic lamination 2 upon exiting the sintering furnace 50. These then have the embodiments such as are shown by way of example in FIGS. 4 to 6.

What is claimed is:

1. An additively manufactured rotationally symmetric magnetic lamination comprising:
at least two material layers for a laminated core of an electrical machine;
wherein each material layer comprises at least two material components separate from one another in their planar extent;
a first material component and a second material component forming a material layer layout;
wherein the at least two material layers have the same material layer layout as the two material components; and
a layout of the at least two material layers is rotationally shifted by a non-zero angle.

2. The magnetic lamination as claimed in claim 1, further comprising a third material layer;
wherein the third material layer is rotationally shifted by the angle in the same direction relative to the second material layer.

3. The magnetic lamination as claimed in claim 1, wherein the at least two material layers are bonded to one another via a sinter bond.

4. The magnetic lamination as claimed in claim 1, wherein the magnetic lamination has a thickness between 300 μm and 2000 μm.

5. The magnetic lamination as claimed in claim 1, wherein each of the material layers has a thickness between 10 μm and 150 μm.

6. The magnetic lamination as claimed in claim 1, wherein the first material component comprises an iron alloy with an austenitic microstructure of at least 25% by total volume of the first material component.

7. The magnetic lamination as claimed in claim 1, wherein the second material component comprises an iron alloy with at least 95% by weight of iron.

8. The magnetic lamination as claimed in claim 7, wherein the second material component has a ferritic or martensitic microstructure.

9. The magnetic lamination as claimed in claim 1, wherein the first material component comprises an iron-chromium-nickel alloy.

10. The magnetic lamination as claimed in claim 9, wherein the first material component comprises an iron-chromium alloy having a chromium content between 22% by weight and 28% by weight.

11. The magnetic lamination as claimed in claim 9, wherein the first material component has a nickel content between 4% by weight and 10% by weight.

12. A laminated core for a rotor of an electric machine, the laminated core comprising a plurality of magnetic laminations wherein each magnetic lamination comprises:
at least two material layers for a laminated core of an electrical machine;
wherein each material layer comprises at least two material components separate from one another in their planar extent;
a first material component and a second material component forming a material layer layout;
wherein the at least two material layers have the same material layer layout as the two material components; and
a layout of the at least two material layers is rotationally shifted by a non-zero angle.

13. The laminated core as claimed in claim 12, wherein an uppermost material layer of a first magnetic lamination and a lowermost material layer of a second magnetic lamination are shifted by the angle.

14. The laminated core as claimed in claim 12, wherein sum of the angles in the laminated core is between 7° and 36°.

15. A process for producing a magnetic lamination, the process comprising:
applying a first printing paste onto a substrate by printing through a stencil;
applying a second printing paste to the substrate such that the two printing pastes are arranged side by side, form a discrete boundary, and form a first material layer;
drying the first material layer;
rotating the orientation of the substrate and/or the stencil about a perpendicular axis to the substrate by a non-zero angle;
applying a second material layer; and
sintering a green body to afford a magnetic lamination.
